(19) United States
(12) Patent Application Publication
(10) Pub. No.: US 2008/0227895 A1
(43) Pub. Date: Sep. 18, 2008

(54) Fire retardant vinyl chloride-based resin composition and molded article thereof

(75) Inventors: Shoji Ito, Shiga (JP); Takeshi Onishi, Shiga (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI PLASTICS, INC., Tokyo (JP)

(21) Appl. No.: 12/153,464

(22) Filed: May 20, 2008

Related U.S. Application Data
(62) Division of application No. 10/533,814, filed on Jun. 3, 2005.

(30) Foreign Application Priority Data
Nov. 5, 2002 (JP) 2002-320677
Sep. 2, 2003 (JP) 2003-309719
Oct. 1, 2003 (JP) 2003-343842

(51) Int. Cl. C08K 5/3462; C08K 5/38; C08K 3/10; C08K 5/3475

(52) U.S. Cl. 524/101; 524/201; 524/406; 524/106; 524/100

(57) ABSTRACT

A fire retardant VC-based resin composition includes 100 parts by weight of a VC-based resin, 0.05 to 8 parts by weight of at least one molybdenum compound anti-smoke agent, and 0.1 to 3 parts by weight of an alkaline compound.

### CROSS REFERENCE TO RELATED APPLICATION

This is a divisional application of patent application Ser. No. 10/533,814 filed on Jun. 3, 2005. The patent application Ser. No. 10/533,814 is based on International Application No. PCT/JP2003/014052 filed Nov. 4, 2003, and claims priority from, Japanese Application Numbers 2002-320677, 2003-309719 & 2003-343842, filed Nov. 5, 2002, Sep. 2 and Oct. 1, 2003, respectively, the disclosure of which is hereby incorporated by reference herein in its entirety.

### BACKGROUND OF THE INVENTION AND RELATED ART STATEMENT

This invention relates to a vinyl chloride-based resin (hereinafter referred to as VC-based resin) composition having excellent fire retardant properties, molding processability, color fastness, and other improved properties, and relates to a rigid molded article prepared therefrom by various molding processes.

VC-based resin compositions are fire retardant due to chlorine contained in their molecules, and further exhibit comprehensive mechanical properties, heat resistance, molding processability, and weather resistance because of various kinds of inorganic additives added thereto in a wide range.

Molded articles from these VC-based resin compositions, especially rigid compositions thereof, with improved properties as described above are widely applied to interior and exterior materials of transport means such as aircrafts, ships and cars; interior and exterior materials of construction; daily goods such as furniture and stationary; housing materials for electronic devices, etc. and parts for semiconductor devices, etc.

The VC-based resin compositions, however, generate a great quantity of smoke and poisonous gases such as chlorine and hydrogen chloride when they are exposed to a temperature higher than their heat resistance limit. Therefore, there have been tried to control generation of such poisonous gases by addition of inorganic additives while optimizing types and amounts thereof to be added.

According to Japanese Patent No. 11-181,204A, for example, there is disclosed that calcium carbonate, talc, and a chlorine-capturing compound are added to a VC-based resin to satisfy the FM standard. The resin is molded to a fire retardant VC-based resin composition of desired shape. The FM standard defines evaluation requirements provided by Factory Mutual System.

The molded article is effective to improve the fire retardant properties, but is not sufficient to control generation of poisonous gases and exhibits poor heat stability when the composition is molded. Further, inferiority in dispersion of these additives causes flocculation thereof and results in imperfect appearance.

Japanese Patent No. 2,000-226,483A suggests a molded article of a fire retardant VC-based resin in which 4 to 60 parts by weight of metal hydroxide, 2 to 40 by weight of zinc stannate fire retardant agent, and 20 to 150 parts by weight of plasticizer are added to 100 parts by weight of the VC-based resin to avoid the above mentioned defects. Although the fire retardant properties, the heat stability of extrusion molding, and the appearance of the molded article are improved, there is a serious problem that the softening temperature is low.

Japanese Patent No. 2,002-226,659 suggests a fire retardant VC-based resin composition in which 0.1 to 2.5 parts by weight of a molybdenum compound or 0.05 to 1.5 parts by weight of metallic molybdenum is added to 100 parts by weight of the VC-based resin. Japanese Patent No. 2,002-284,948 proposes a VC-based resin composition in which not less than 1 part by weight of a molybdenum compound, not less than 1 part by weight of a hydroxyl compound, and not less than 3 parts by weight of a titanium compound are added to the VC-based resin, the sum of additives being 8 to 25 parts by weight. However, these VC-based resin compositions hardly meet requirements as a material for semiconductor rinsing cistern or its neighboring units with regard to the fire retardant properties and the stability in warm water, because it is necessary to rinse semiconductors in warm water without causing trouble such as discoloration due to contact with water.

These defects in the stable color fastness in warm water and the fire retardant properties can be improved to some extent by addition of a lead compound, which is generally recognized as one of environmental environmentally affective substances and is apt to restrict its use. It has therefore been expected to improve the stable color fastness and fire retardant properties by means of another procedure.

Accordingly, it is an object of this invention to provide a fire retardant VC-based resin composition with excellent fire retardant properties, molding heat stability, and other improved properties, as well as good appearance and higher softening temperature as a molded article, while exhibiting stable and sufficient color fastness in warm water and resistance to solvents without adding a lead compound, and to provide rigid molded articles prepared therefrom by various molding processes.

### SUMMARY OF THE INVENTION

In order to achieve the above described objects, a fire retardant VC-based resin composition of the invention comprises 100 parts by weight of a VC-based resin, 0.05 to 10 parts by weight of at least one anti-smoke agent selected from zinc-, molybdenum- or tin compounds, and 0.01 to 10 parts by weight of at least one compound selected from aluminum- and magnesium-metal hydroxide and zeolite.

The composition may further comprise at least one compound as a processing aid selected from polymethacrylate and polyalkylacrylate.

The composition of the invention may comprise a molybdenum compound as the anti-smoke agent in an amount of 0.05 to 8 parts by weight and also comprise 0.1 to 3 parts by weight of an alkaline compound.

The composition of the invention may comprise 0.1 to 8 parts by weight of a surface-coated anti-smoke agent in which an alkaline compound or mixture thereof with titanium oxide is used as a nucleating agent and the surface is coated with a molybdenum compound, the processing aid being not comprised.

The molybdenum compound is preferably 5 to 50% by weight of the surface-coated anti-smoke agent.

Decomposition time of the fire retardant VC-based resin composition is preferably not less than 15 minutes determined by the dynamic heat stability evaluation using a plastomil.

The fire retardant VC-based resin composition is molded by extrusion molding, calender press molding, i.e., a combined molding process to calender and successively press the resin, or extrusion-followed by press molding, i.e., a combined molding process to extrude and successively press the resin, to yield a rigid molded article.

The molded article preferably exhibits a color difference value (Δa) of −0.5 to +0.5 before and after immersion thereof in warm water determined by a warm water discoloration test at 60° C. for 48 hours.

The rigid composition of the invention preferably exhibits average heat release value (AHRR) of 65 kW/m² or less determined by ASTM E1354, average smoke extinction volume (ASEA) of 800 m²/g or less and Vicat softening temperature of 70° C. determined by JIS K 7206 B under a load of 49.03 N. ASEA is a value expressing quantity of light blocked by smoke when one gram of a molded article is burned in a definite space, which is converted into virtual volume of given smoke concentration (density), and the more the volume increases, the higher the smoke density increases.

### DETAILED DESCRIPTION OF THE PREFERRED EMBODIMENTS

The VC-based resin of this invention may include not only a homopolymer such as polyvinylchloride and chlorinated polyvinylchloride but a copolymer such as vinyl chloride-vinyl acetate copolymer, vinyl chloride-ethylene copolymer and vinyl chloride-acryl copolymer of suitably soft and rigid nature having a degree of polymerization ranging from about 400 to 1,400.

An anti-smoke agent to be added to the VC-based resin of this invention is at least one compound selected from zinc-, molybdenum-, and tin compounds and preferably zinc-, and molybdenum compounds above all.

The zinc compounds include zinc borate, zinc oxide, zinc hydroxy-stannate, zinc stannate, zinc soap, etc.

The molybdenum compounds include molybdenum oxide, molybdenum trioxide, molybdic acid, ammonium molybdate, ammonium octamolybdate, zinc molybdate, calcium molybdate, zinc-calcium molybdate, sodium molybdate, molybdenum disulfide, melamine β-molybdate, etc.

The tin compounds include tin oxide, etc.

Each of these ant-smoke agents may either be added as it is or coated on other additives and added.

The other additives to be coated with the anti-smoke agents include organic compounds such as calcium carbonate and talc. Further, there may be coated hydroxide of metals, i.e., aluminum or magnesium, and zeolite, which are used as an essential component of this invention, with the anti-smoke agents.

The anti-smoke agents exhibit actions to promote carbonization of the VC-based resin compositions when they are burned and to reduce volume of smoke, thereby fire retardant properties of the present molded article being improved.

A too small amount of anti-smoke agents to be added would fail to exhibit the above mentioned actions, while an excess thereof would cause a decrease in properties of the molded article, their inferior distribution in the article and accelerate deterioration of thermal stability when the resin is molded. Accordingly, there may be added 0.05 to 10 parts by weight of anti-smoke agents to 100 parts by weight of the VC-based resin in this invention.

Decomposition and deterioration behavior of the VC-based resin with the rise of temperature is as in the following: initiation of the HCl-elimination reaction within the temperature range up to 220° C. in which the resin is molded, stimulation of the HCl elimination reaction in the vicinity of 220 to 370° C. and backbone chain cleavage and carbon combustion within the temperature range, for example, higher than 450° C.

Decompositions within both temperature ranges up to 220° C. in which the resin is molded and higher than 450° C. in which backbone chain cleavage and carbon combustion are occurred are herein referred to as low temperature decomposition and high temperature one, respectively.

The anti-smoke agents used in this invention, especially molybdenum compounds, sufficiently function as a high temperature decomposition promoter and rapidly accelerate carbonization of the resin within the temperature range of backbone chain cleavage and carbon combustion. In a molded article of VC-based resin composition which comprises no molybdenum compound, carbonization thereof is not promoted within this temperature range and, as a result, a combustible gas is generated by the HCl elimination reaction in the polyethylene formation process. This results in inferior fire retardant properties even if the resin comprises a fire retardant.

As has been described above, the molybdenum compounds which promote the high temperature decomposition successfully are added in an amount similarly as the above mentioned anti-smoke agent, that is, 0.01 to 10, preferably 0.05 to 8 and more preferably 0.5 to 5 parts by weight to is added to 100 parts by weight of the VC-based resin. The molybdenum compounds in a smaller amount promote high temperature decomposition unsuccessfully, while those compounds in an excessive amount result in inferior distribution thereof in the molded article thereby seldom yielding a product of high quality.

The molybdenum compounds are preferably used in a liquid form rather than a powder to form a molded article of high quality without causing distribution inferiority but, even in a powder form thereof, it is also possible to yield high quality by using a mixture of the powder with other liquid additives such as an organic tin stabilizer or homogeneously mixing it in a compounding step.

The molybdenum compounds used in this invention include molybdenum oxide, molybdenum trioxide, molybdic acid, ammonium molybdate, ammonium dimolybdate, ammonium heptamolybdate, ammonium octamolybdate, ammonium decamolybdate, zinc molybdate, calcium molybdate, sodium molybdate, molybdenum disulfide, phosphorus molybdate, potassium phosphorus molybdate, calcium phosphorus molybdate, zinc phosphorus molybdate, melamine β-molybdate, etc., which may either be used as a single compound or a mixture of two or more of them.

These molybdenum compounds may be used with a fire retardant aid such as, for example, molybdenum oxide, tin oxide, zinc oxide, vanadium oxide, ammonium polyphosphate and phosphoric ester, which may also be used as a single compound or a combination of two or more of them.

Each molybdenum compound may either be added directly to the VC-based resin as it is or coated to other additives and then added thereto. The other additives include those compounds generally compounded to the VC-based resin, and preferably talc, silica, titanium oxide, etc.

Especially in the case of a VC-based resin composition comprising an organic tin stabilizer, a problem of color change towards blue green arises when only a molybdenum compound is compounded in the resin after a molded article thereof is soaked in warm water.

The color change has not been fully elucidated yet, but at least confirmed by the inventors that it would be attributable to changes in valence of a molybdenum metal. It is also described in ENCYCLOPEDIA CHIMICA (Sankyo Publishing Co., Ltd.) that molybdenum compounds of hexa-valent show a water-white color and are the most stable, while tinging blue with a decrease in valence.

The inventors have investigated how to control the decrease in Mo valence of molybdenum compounds and found that the color change due to warm water soaking can be stably prevented by adjusting the hydrogen ion concentration of the molded article to neutral during soaking.

That is to say that the reaction system of the VC-based resin tends to be acidic in the step of molding within the above mentioned temperature range due to heat deterioration caused by HCl elimination reaction.

The organic tin stabilizer to be added to the VC-based resin includes those compounds of laurate, maleate and mercaptide. As they are synthesized from acidic materials typically represented by lauric acid, maleic acid, thioglycol acid, etc., the stabilizer itself assumes acidic in nature.

When a molybdenum compound as the fire retardant or high temperature decomposition promoter is added to a VC-based resin which comprises a tin stabilizer, the Mo metal is exposed under an acidic condition thereby decreasing the valence of Mo, which would cause color change.

According to this invention, there is added a basic compound as a hydrogen ion concentration adjustor is added to the VC-based resin to control a decrease in the valence.

Hydrogen ion concentration (pH) in an aqueous solution is adjusted to 5.5 to 8.5 by addition of a basic compound after a the color change test in warm water is done for 48 hours at 60° C., which stably secures resistance to color change in warm water.

In other words, the basic compound is added to the VC-based resin for the purpose of prevention color change caused by warm-water soaking.

Further, the basic compound functions as an agent to inhibit the low-temperature degradation in this invention and avoids forming molded articles of unsatisfied burning appearance due to degradation promoted by a molybdenum compound even within the range of low temperature, i.e., molding temperature. The basic compound is also added to protect a molding machine from corrosion caused by a slight amount of hydrochloric acid which is formed by degradation within the low temperature range.

An excess amount of such a basic compound to be used in this invention hardly yields a satisfactory molded article because of a decrease in heat stability depending on the hydrogen ion concentration, while an insufficient amount thereof does not result in resistant to color change in warm water successfully. The basic compound is added in an amount of 0.1 to 3 parts by weight, and preferably 0.5 to 2 parts by weight to 100 parts by weight of the VC-based resin.

The basic compound includes inorganic compounds, for example, alkaline metal oxide or hydroxide; basic salt of carbonic acid, sulfuric acid, sulfurous acid, phosphoric acid and phosphorous acid; basic metal oxide such as beryllium oxide, magnesium oxide, calcium oxide, strontium oxide, barium oxide, silicon oxide, aluminum oxide and zinc oxide; basic inorganic pigment such as lime carbonate, ultramarine, barium sulfate and precipitated barium sulfate; and dolomite compounds, as well as organic compounds, for example, urea and urea derivatives such as thiourea and N,N′-diphenylthiourea; aminocarbonic acid derivatives such as β-aminocrotonic acid ester, N-lauroyllysine, tris(2-hydroxyethyl) isocyanurate and tris(epoxypropyl) isocyanurate; indoles such as 2-phenylindole; polyamine such as N,N″-diphenylethylenediamine, diethylenetriamine and hexamethylenetetramine; amine derivatives such as phenyl-α-naphthylamine, aldol-α-naphthylamine and 6-ethoxy-2,2,4-trimethyl-1,2-dihydroquinoline; benzotoriazoles such as (2′-hydroxyphenyl)benzotriazole; hindered amine derivatives such as bis(2,2,6,6-tetramethylpiperazinyl)-4-cevacate; hydrazine derivatives; thiocarbamine derivatives; and metal soap.

Urea derivatives, aminocarboxylic acid derivatives, dolomite derivatives and metal soap are preferable above all from a standpoint of their compatibility to the VC-based resin.

Tioureas are typical examples of the above mentioned urea derivatives and represented by the following general formula:

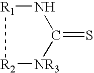

The thiourea derivatives of this formula include 1-ethyl-3-phenylthiourea, 1,3-diphenylthiourea, 1,3-diethylthiourea, 1-ethyl-3-chlorophenylthiourea, 1-ethyl-3-(2-hydroxyethyl)thiourea, 1-(2-thiazolyl)-3-phenylthiourea, 1,3-distarylthiourea, 1,3-dibehenylthiourea, 1-ethylthiourea, 1-P-bromophenyl-3-phnylthiourea, 1-(2-thiophenyl)-3-phenylthiourea, 1,3-bis(2-hydroxyethyl)thiourea, 1-p-aminophenyl-3-phenylthiourea, 1-p-nitrophenyl-3-phenylthiourea, 1-p-hydroxyphenyl-3-phenylthiourea, 1,3-di-m-chlorophenylthiourea, ethylenethiourea, thiourea, 1-methyl-3-p-hydroxyphenylthiourea, 1-phenylthiourea, 1-m-nitrophenylthiourea, 1-p-nitrophenylthiourea, 1-p-aminophenylthiourea, 1,3-dimethylthiourea, 1,3-dicyclohexylthiourea, 1-phenyl-3-p-chlorophenylthiourea, 1-phenyl-3-p-methoxyphenylthiourea, 1,1-diphenylthiourea, 1,1-dibenzyl-3-phenethylthiourea, 1-phenyl-3-(2-hydroxyethy)thiourea, etc.

The above mentioned aminocarboxylic acid derivatives include, for example, 1,3-butanediol-bis(3-aminocrotonate), methyl β-aminocrotonate, 1,4-butane-bis-β-aminocrotonate, 2,6-dimethyl-3,5-diethoxycarbodehydro-pyridine, 6-amino-1,3-dimethyluracil, etc.

An example of the metal soap is represented by the general formula of M(OOCR)ₙ wherein M is a metal such as Ba, Ca, Al and Mg, and R is an alkyl group derived from stearic acid, lauric acid, 2-ethylhexysonic acid, etc. and typically includes barium stearate, magnesium stearate, k etc.

The dolomite compound includes widely produced natural dolomites used as wall material, refractory for iron making, etc. such as dolomite (MgCO₃.CaCO₃), magnesia quick lime (MgO.CaO) and magnesia slaked lime (MgO(OH)₂.Ca(OH)₂; synthetic dolomite, the chemical composition being a double salt of calcium carbonate and magnesium carbonate and the weight ratio of magnesium and calcium being 5:95 to 95:5 calculated as MgO:CaO; dolomite derivatives modified by calcining or weathering natural or synthetic dolomite without substantially changing the metallic element composition, such as dolomite cement, slightly calcined dolomite, completely calcined dolomite, dolomite clinker, slaked dolomite prepared by slaking slightly calcined dolomite with water, dolomite plaster and synthetic magnesia-dolomite clinker; and derivatives prepared by similarly modifying natural mineral or synthetic double salt having the same ratio of calcium and magnesium as the above mentioned synthetic dolomite, such as akermanite (Ca₂MgSi₂O₃), diopsid (CaMg(SiO₃)₂) and various kinds of slugs. The dolomite compound may either be used as a single substance or a mixture of two or more of them.

Further, there may be used a surface-treated dolomite compound as a single substance or a mixture of two or more, which is prepared by treating it with a surface treating agent such as organic acid, organic metal salt and polyalcohol.

The basic compound is preferably precipitating barium sulfate in particular, which also functions as a pigment similarly as titanium oxide and is highly chemical resistant.

There may also be used a coated fire retardant agent in which the basic compound or its mixture with titanium oxide as a nucleating agent is coated with the molybdenum compound as a coating agent to neutralize the fire retardant agent as a whole so that the valence of molybdenum is kept unchanged.

Titanium oxide to be mixed with the basic compound as a nucleating agent may either be that of anatase or rutile structure, although the latter is preferable from a standpoint of light stability.

There may also be used a surface-treated titanium oxide similarly as the dolomite compound, which is prepared by treating it with a surface treating agent such as Al—Si— and Al—Si—Zr compound.

An insufficient amount of the molybdenum compound to be coated hardly results in an effect to promote high-temperature decomposition or a fire retardant effect, while an excess amount thereof relatively reduces an amount of the nucleating agent to be mixed and exhibits less resistance to color change in warm water and an effect to control low-temperature decomposition. The molybdenum compound is added in an amount of 5 to 50% by weight, and preferably 10 to 30% by weight as MoO₃ (or 1 to 20% by weight and preferably 5 to 10% by weight as metallic molybdenum) to total weight of the molybdenum compound and the nucleating agent. A method for coating the molybdenum compound on the nucleating agent is not limited in particular and may be those manners conventionally done, for example, to support various compounds on a support in the catalyst production process.

To be concrete, the nucleating agent is coated with the molybdenum compound as in the following manners: (1) The molybdenum compound or its precursor is dissolved in water or other solvent in the presence of the nucleating agent and then insolubilize it by controlling pH to coat on the nucleating agent, followed by drying and calcinations. (2) A solution of the molybdenum compound or its precursor is coated on the nucleating agent by spraying, followed by drying and calcinations. (3) The nucleating agent and the melted molybdenum compound or its precursor are mixed to form a solid solution thereof, which is then milled.

A technique described in U.S. Pat. Nos. 3,726,694 and 387,486 are especially successful.

According to the above mentioned technique, one or not less than two kinds of aqueous dispersions of a nucleating agent, which have been prepared in advance, are introduced into a concentrated aqueous dispersion of a molybdenum compound simultaneously or stepwise so that a predetermined amount of the molybdenum compound is deposited on the surface of the nucleating agent. A relatively thick and dense slurry or paste thus yielded is reacted while adjusting pH and heating to form a mixture, which is then dried, calcined, and milled, so that an agglomerate formed in the drying step is removed.

An insufficient amount of the fire retardant in which the surface of the nucleating agent is coated with the molybdenum compound hardly exhibits an effect to promote high-temperature decomposition or a fire retardant effect, while an excess amount thereof saturates the effect. Thus, the fire retardant is preferably used in an amount of 0.1 to 8 parts by weight to 100 parts by weight of the VC-based resin.

When the surfaced-coated fire retardant is used, the molybdenum compound, the basic compound and titanium oxide are homogeneously mixed by simply mixing it in the VC-based resin, thereby the molybdenum compound being dispersed more easily compared with independent addition thereof and the basic compound, because it is difficult to obtain a homogeneously dispersed situation when the molybdenum compound is added as a single substance. Further, the fire retardant effect or the effect to promote high-temperature decomposition is obtainable even if a small amount of the molybdenum compound is added.

There may also be used a white pigment comprising titanium oxide as a nucleating agent in the surfaced-coated fire retardant together with the basic compound. Such a simultaneous use of the white pigment (titanium oxide) as the nucleating agent results in remarkable resistance to high-temperature color change more stably compared with the basic compound used as a single nucleating agent and, at the same time, improves dispersibility of the surface-coated fire retardant.

According to this invention, it is possible to use known flame retardants such as phosphoric ester, polyphosphoric ester and orthophosphoric ester, radical generating agents such as peroxide and perchlorate, and cross-linking agents such as triazinethiol compound together with the fire retardant.

An amount of the flame retardants to be simultaneously used is not especially limited is generally less than 10% by weight of the inorganic fire retardant because an excessive addition thereof causes unsatisfactory dispersion and deterioration of heat stability as described above.

Metal hydroxide to be added to the VC-based resin together with the fire retardant is at least one compound selected from magnesium- and aluminum hydroxides which include, in the concrete, Mg(OH)₂, Al(OH)₃, 1.25Mg(OH)₂.Al(OH)₃.2CO₃.yH₂O, Al(OH)₃ NaHCO₃, Mg(OH)_{4.5}AL₂(OH)₁₃.CO₃.3.5H₂O, etc.

Preferable zeolite to be used instead of the metal hydroxide or used together therewith is represented by the following general formula:

Mₓ/p[(AlO₂)ₓ.(SiO₂)_{y}]zH₂O

wherein M is a metal ion of valence p such as Ca, Mg, Na and K, x+y represents a number of tetrahedron per unit lattice and is an integer of 10 to 200, x and y are integers which satisfy a formula 0<x/y≦1.1 and z represents mol of water molecule and is an integer of 4 to 300.

Above mentioned zeolite is a kind of tectosilicate minerals including various natural and synthetic products, although it is preferable in this invention to use synthetic zeolite of A type in which the metal ion M is Na or Ca.

These metal hydroxides and zeolite enhance heat stability of the VC-based resin of this invention and exhibit an effect to improve molding workability, especially the workability in the continuous extrusion-pressing process conducted under a severer molding condition compared with a calender pressing process or extruding process.

An insufficient amount of the metal hydroxides or zeolite hardly exhibits the above mentioned effect, while an excess amount thereof, contrast, results in not only a lowering of physical properties of the molded article but also inferiority in dispersion of the minerals in it. Thus, these metal hydroxides and zeolite are used in this invention in an amount of 0.1 to 10 parts by weight and preferably 0.5 to 8 parts by weight to 100 parts by weight of the VC-based resin.

Further, there may be simultaneously used other metal hydroxide known as a heat stabilizing agent, such as calcium hydroxide and hydrotalcite (Mg.Al.Zn(CO₃)ₓ(OH)_{y}), together with the above mentioned metal hydroxides or zeolite if the other hydroxide is effective to improve the heat stability. An amount of the heat stabilizing agent to be simultaneously used is not especially limited, but is preferably less than 10% by weight to a total amount of magnesium or aluminum hydroxide or zeolite, because an excessive addition thereof causes inferiority in dispersion.

A processing aid used in this invention is at least one compound selected from poly(alkyl methacrylate) and poly(alkyl acrylate) preferably having molecular weight of about 200,000 to 5,000,000 and more preferably about 500,000 to 3,000,000.

The poly(alkyl methacrylate) and the poly(alkyl acrylate) include poly(methyl methacrylate, poly(butyl methacrylate), etc. and poly(ethyl acrylate), poly(butyl acrylate), poly(2-ethylhexyl acrylate, etc., respectively. Especially preferable processing aid is poly(methyl methacrylate) having molecular weight of 500,000 to 3,000,000 and an alkyl metacrylate/alkyl acrylate copolymer having molecular weight of 500,000 to 3,000,000 and a MMA copolymerization ratio of 100 to 50, in which the alkyl radical is methyl or butyl in the former monomer and ethyl, butyl or 2-ethylhexyl in the latter monomer, respectively, for example, a methyl methacrylate/ethyl acrylate (90/10) copolymer having molecular weight of about 1,500,000.

Such the processing aid is effective to settle inferiority in dispersion of various additives in the molded article formed by molding the VC-based resin composition of this invention.

The fire retardant VC-based resin composition of this invention is useful for rigid molded article and comprises no plasticizer at all or in a small amount as 5 parts by weight or lees to the VC-based resin in an amount of 100 parts by weight, which tends to cause heterogeneous dispersion of various additives in the VC-based resin. The processing aid is used to settle this defect.

An insufficient amount of the processing aid to be added does not exhibit the settling effect as described above, while an excess thereof causes shearing heat build-up of the VC-based resin composition in the molding process and makes it difficult to proceed the molding process stably. Thus, the processing aid is used in an amount of 0.5 to 10 parts by weight and preferably 1.5 to 8 parts by weight to 100 parts by weight of the VC-based resin.

When the basic compound and titanium oxide are coated with the molybdenum compound, it is not necessary to use the processing aid because they are effective to successfully disperse the molybdenum compound.

There may be simultaneously used a known processing aid capable of settling inferiority in dispersion of additives together with the above mentioned aid, such as a methyl methacrylate-butyl acrylate-styrene terpolymer having molecular weight of 300,000. An amount of such a known processing aid to be simultaneously used is not especially limited but preferably 10 parts by weight or less of the original processing aid, because an excess thereof increases the shearing heat build-up as described above.

The fire retardant VC-based resin composition of this invention is prepared by milling and homogeneously mixing predetermined amounts of a VC-based resin, a fire retardant, metal hydroxide or zeolite, a processing aid if necessary, various kinds of additives such as a flame retardant, a heat stabilizing agent including metal hydroxide and a colorant by means of a blender or Henschel mixer.

Molding properties of the thus prepared fire retardant VC-based resin composition depends on whether the composition is successfully heat-stable or not.

The heat stability is evaluated on the basis of decomposition time according to dynamic heat stability evaluation method using a plastomill, in which the decomposition time refers to, for example, a time when the torque increases over 10% after rising temperature to 200° C.

The decomposition time useful in this invention is more than 15 minutes, while that of 15 minutes or less would decrease the heat stability in the molding process,

The maximum decomposition time in this invention is not limited in particular but is nearly 30 minutes, because too long decomposition time interferes with the combusting carbonization and increases the smoking index so that the FM standard is not satisfied.

The molded article of this invention is molded by means of extrusion molding, calender-press molding or extrusion-followed by press molding of the present VC-based resin composition into various forms of film, sheet, board, pipe, irregular shape, etc.

According to the calender-press molding process, strain developed in the composition during the calender molding is recovered in the process of press molding because of mild molding conditions thereof, thereby yielding a molded board product without strain. However, when the board product is subjected to a thermal processing to mold into housing materials for household electric appliances, electronic devices, etc., or parts for semiconductor and the like, the strain of the calender molding is again developed to cause a so-called gloss-throwback phenomenon in the molded article.

According to the calender-press molding process, as only a thin board is formed in a step of calender molding, it is necessary to laminate plural thin boards in a step of press molding to yield a board of desired thickness. The thus formed laminate it self or various articled molded therefrom is less resistant to solvents and would cause a cleavage during washing with solvents.

Further, in the calender-press molding process, although plural thin boards molded in the step of calender molding are laminated to form a thick board in the step of press molding as described above, while thickness of each thin board scatters to some extent depending on the molding condition, etc. As scattering of thickness is also occurs in the step of press molding depending on the condition, both of such scattering are synergized each other, thereby causing inferiority in the thickness consistency.

The extrusion molding process as well as the extrusion-followed by press molding process are conducted under severer conditions of high temperature and high pressure compared with the calender-press molding process and do not arouse a problem of gloss-throwback. Further, a board of desired thickness is obtained by a single extrusion step in these processes without arousing a problem of cleavage or resistance to solvents. The extrusion molding process, however, arouses other problems of corrugation of the board and heterogeneous thickness thereof.

On the other hand, according to the extrusion-followed by press molding process, no problem arouses with regard to the gloss-throwback and the cleavage or resistance to solvents, while a phenomenon of corrugation does not occur because the board is extruded and then soon pressed successively and, in addition, a board of desired thickness is obtained with high consistency of thickness. All of these advantages can not be attained by the other two processes as described above.

It is important that a color difference value Δa of the thus molded article should be in the range of −0.5 to +0.5 before and after a color change test in warm water at 60° C. for 48 hours.

Although a situation of a color difference value Δa=0, i.e., no color change, is the most preferable, the value fallen in the above mentioned range is sufficiently practical. The color difference value of Δa<−0.5 or Δa>+0.5 is not practical for the molded articles which always or frequently come into contact with warm water, such as a semiconductor washing tank or peripheral parts thereof, because the color changes while they are used.

The color difference is significantly observed when a molybdenum compound as a flame retardant or high-temperature decomposition promoter is used as described above. In this case, the color difference value Δa within the range of −0.5 to +0.5 can be attained by adjusting hydrogen ion concentration (pH) of an aqueous solution after the color change test in warm water at 60° C. for 48 hours to 5.5 to 8.5.

The hydrogen ion concentration (pH) of 5.5 to 8.5 is easily and securely adjusted by adding a basic compound or titanium oxide in an amount as described above.

The molded article of this invention exhibits marked fire retarding properties, which may be evaluated by means of the Cone calorimeter according to ASTM E1354.

The evaluation covers fire retardant properties evaluated by a combustion test using the Cone calorimeter and includes a maximum heat release value of combustion (also referred to as maximum heat value or PHRR) per unit area and unit time (unit: kW/m²), an average (also referred to as average heat release value or AHRR; unit: kW/m²), a total heat value (referred to as THR; unit: MJ/m²), an average mass loss rate (also referred to as mass loss rate or AMLR; unit: g/sec*m²), a maximum value of smoke extinction volume (also referred to as maximum smoke extinction volume or PSEA; unit: m²/g) and an average value of smoke extinction volume (also referred to as average smoke extinction volume or ASEA; unit: m²/g).

The Factory Mutual Research Corp. under the Factory Mutual System provided an evaluation standard, which has been effectively employed as an indication of fire retarding properties.

The evaluation standard (referred to as FM Standard) covers indications such a flammability index (FPI) indicating fire retardant properties, a smoke emitting index (SDI) which indicating smoking properties and a corrosion index (CDI) indicating generation of corrosive gas, which are determined according to FM Standard No. 4,910 “FMRC: Clean Room Materials Flammability Test Protocol”.

As a test piece to be evaluated according to FM Standard should be presented to the System where the evaluation is done, it takes a long time inefficiently to get the result of evaluation.

Instead of FM Standard, indicators of fire retarding properties in this invention are evaluated by means of the Cone calorimeter according to the combustion test of ASTM E1354, thereby the evaluation being done by our selves.

The flammability index (FPI) evaluated according to FM Standard is extremely correlated to evaluated values regarding heat release such as the maximum heat release value (PHRR), the average heat release value (AHRR) and the total heat release value (THR) determined by means of the Cone calorimeter.

Further, the smoke emitting index (SDI) evaluated according to FM Standard is extremely correlated to indices regarding the smoke extinction volume such as the maximum smoke extinction volume (PSEA) and the average smoke extinction volume (ASEA) determined by means of the Cone calorimeter.

Furthermore, the corrosion index (CDI) evaluated according to FM Standard is extremely correlated to an index regarding mass loss such as the average mass loss rate (AMLR) determined by means of the Cone calorimeter.

Accordingly, indices of FM Standard can be effectively obtained by evaluating the fire retarding properties by means of the Cone calorimeter.

According to FM Standard, it is required that the flammability index (FPI) is less than 6 and the smoke emitting index (SDI) is less than 0.4.

According to this invention, preferably, the maximum heat release value (PHRR) is less than 130 kW/m², the average heat release value (AHRR) is 82 kW/m², the total heat value (THR) is less than 100 MJ/m², the average mass loss rate (AMLR) is 13 g/sec*m², the maximum smoke extinction volume (PSEA) is 1,500 m²/g and the average smoke extinction volume (ASEA) is less than 1,000 m²/g so that these indices are the same as or higher than those values required by FM Standard. As the average heat release value (AHRR) and the average smoke extinction volume (ASEA) above all are dominant with regard to the fire retarding properties, it is especially preferable that AHRR is less than 65 kW/m² and ASEA is less than 800 m²/g.

With regard to the thermal properties of the present molded article, it is preferable that the Vicat softening temperature is more than 70° C. determined under load of 49.03 N according to JIS K 7206.

### EXAMPLES

### Examples 1 to 13 and Comparative Examples 1 to 10

Flame retardants, metal hydroxide or zeolite, processing aids and stabilizing agents in respective amounts as show in Tables 1 and 2 were added to a vinyl chloride resin (degree of polymerization (DC) 800; vinyl chloride homopolymer) to prepare fire retardant VC-based resin compositions and comparative products.

In tables 1 and 2, details of each item are as in the following:

An amount of additives is based on part by weight;
Vinyl chloride resin (degree of polymerization (DC) 800): available from Taiyo PVC Co., Ltd. as a trade name “TH-800”;
Flame retardant 1: zinc hydroxystanate; available from Alcan Chemical Co., Ltd. as a trade name “Flamtard H”;
Flame retardant 2: ammonium molybdate; available from Nipponn Inorganic Colour Co., Ltd. as a trade name “Molyamm AHM”;
Metal hydroxide: magnesium hydroxide; available from Kyowa Chemical Industry as a trade name “Magsarat F”;
Zeolite: Na-A type zeolite; available from TOSO Co. as a tradename “GSL-1000”;
Processing aid: methyl methacrylate copolymer; available from Rohm & Haas Co. as a trade name “K-120ND”;
Calcium silicate: additives as a dynamic viscosity modifier; available from TOKUYAMA Co., ltd. as a trade name “SOLEX”;
Stabilizing agents:
   Powder tin stabilizer; available from Nitto Chemical Industry as a trade name “MA30”;
   Liquid tin stabilizer; available from the same company as a Trade “N-2000”;
Fire retardant: ammonium polyphosphate; available from RINKAGAKU KOGYO Co., Ltd. as a trade name “Nova White Da-6”;
Hydroperoxide: available from NOF CORPORATION as a trade name “PERCUMYL”;
Cross-linking agent: triazinethiol; available from SANKYO KASEI Co., ltd as a trade name “Jisnet DB”;
Heat stabilizing agent: hydrotalcite; available from Kyowa Chemical Industry as a trade name “ALCAMIZER”.

TABLE 1

| | Example | | | | | | |
|---|---|---|---|---|---|---|---|
| | 1 | 2 | 3 | 4 | 5 | 6 | 7 |
| VC-based | 100 | 100 | 100 | 100 | 100 | 100 | 100 |
| resin | | | | | | | |
| Flame | 2 | 4 | 4 | 4 | 8 | 1 | 4 |
| retardant 1 | | | | | | | |
| Flame | 0 | 0 | 0 | 0 | 0 | 0 | 0 |
| retardant 2 | | | | | | | |
| Metal | 0.5 | 0.5 | 0.5 | 2 | 0.5 | 8 | 0.5 |
| hydroxide | | | | | | | |
| Zeolite | 0 | 0 | 0 | 0 | 0 | 0 | 0 |
| Processing | 1.5 | 1.5 | 3.5 | 1.5 | 1.5 | 1.5 | 8 |
| aid | | | | | | | |
| Powder Ti | 3 | 3 | 3 | 3 | 3 | 3 | 3 |
| stabilizer | | | | | | | |
| Ammonium | — | — | — | — | — | — | 10 |
| polyphosphate | | | | | | | |
| Hydroperoxide | — | — | — | — | — | — | — |
| Triazinethiol | — | — | — | — | — | — | — |
| Hydrotalcite | — | — | — | — | — | — | — |

| | Example | | | | | |
|---|---|---|---|---|---|---|
| | 8 | 9 | 10 | 11 | 12 | 13 |
| VC-based | 100 | 100 | 100 | 100 | 100 | 100 |
| resin | | | | | | |
| Flame | 4 | 0 | 2 | 2 | 2 | 2 |
| retardant 1 | | | | | | |
| Flame | 0 | 4 | 0 | 0 | 0 | 0 |
| retardant 2 | | | | | | |
| Metal | 0 | 0.5 | 0.5 | 0.5 | 0.5 | 0.5 |
| hydroxide | | | | | | |
| Zeolite | 0.5 | 0 | 0 | 0 | 0 | 0 |
| Processing | 1.5 | 1.5 | 1.5 | 1.5 | 1.5 | 1.5 |
| aid | | | | | | |
| Powder Sn | 3 | 3 | 3 | 3 | 3 | 3 |
| stabilizer | | | | | | |
| Ammonium | — | — | 0.5 | — | — | — |
| polyphosphate | | | | | | |
| Hydroperoxide | — | — | — | 0.5 | — | — |
| Triazinethiol | — | — | — | — | 0.5 | — |
| Hydrotalcite | — | — | — | — | — | 0.3 |

TABLE 2

| | Comparative Example | | | | | | | | | |
|---|---|---|---|---|---|---|---|---|---|---|
| | 1 | 2 | 3 | 4 | 5 | 6 | 7 | 8 | 9 | 10 |
| VC-based | 100 | 100 | 100 | 100 | 100 | 100 | 100 | 100 | 100 | 100 |
| resin | | | | | | | | | | |
| Flame | 0 | 4 | 4 | 4 | 4 | 4 | 0 | 15 | 4 | 4 |
| retardant | | | | | | | | | | |
| Metal | 0 | 0 | 0 | 0.5 | 0 | 0 | 0 | 0.5 | 15 | 0.5 |
| hydroxide | | | | | | | | | | |
| Processing | 1.5 | 1.5 | 1.5 | 0 | 1.5 | 1.5 | 1.5 | 1.5 | 1.5 | 15 |
| aid | | | | | | | | | | |
| Powder Sn | 3 | 3 | 3 | 3 | 6 | 0 | 0 | 3 | 3 | 3 |
| stabilizer | | | | | | | | | | |
| Liquid Sn | 0 | 0 | 0 | 0 | 0 | 3 | 4 | 0 | 0 | 0 |
| stabilizer | | | | | | | | | | |
| Calcium | 0 | 0 | 0.5 | 0 | 0 | 0 | 0 | 0.5 | 0 | 0 |
| silicate | | | | | | | | | | |

### [Evaluation of Extrusion Molding Properties]

The results of evaluation obtained as in the following manners are shown in Tables 3 and 4.
(1) Determination of fire retardant properties: Compositions prepared by Examples 1 to 13 and Comparative Examples 1 to 10 were extruded to mold board articles of 5 mm in thickness, followed by determination of their AHRR (kW/m²) and ASEA (m²/g) using Atlas's Cone calorimeter according to ASTM E1354.
(2) Evaluation of thermal properties: The Vicat softening temperature (° C.) of the thus molded articles was determined under load of 49.03 N according to JIS K 7206 B.
(3) Evaluation of molding properties: Compositions prepared by Examples 1 to 9 and Comparative Examples 1 to 10 were subjected to determination of decomposition time at 200° C. according to the method for evaluating dynamic heat stability by means of a plastomill. A time (minute) when the torque begins to increase over 10% is defined as the decomposition time.
(4) Appearance evaluation of molded article: The same compositions were extruded by means of a twin-screw extruder to mold board articles of 1 mm in thickness, followed by visual evaluation of the superficial dispersing condition according to the following criteria:
   ◯: no aggregate with excellent appearance
   Δ: slightly aggregated but commercially acceptable
   x: obviously aggregated and commercially unacceptable

TABLE 3

| | Example | | | | | | |
|---|---|---|---|---|---|---|---|
| | 1 | 2 | 3 | 4 | 5 | 6 | 7 |
| AHRR | 31 | 28 | 28 | 20 | 25 | 33 | 27 |
| (kW/m²) | | | | | | | |
| ASEA | 765 | 738 | 735 | 672 | 703 | 776 | 730 |
| (m²/g) | | | | | | | |
| Vicat | 77 | 77 | 77 | 77 | 77 | 77 | 77 |
| softening | | | | | | | |
| temperature | | | | | | | |
| (° C.) | | | | | | | |
| Dynamic | 23 | 20 | 19 | 22 | 15 | 25 | 16 |
| thermal | | | | | | | |
| stability | | | | | | | |
| (min) | | | | | | | |
| Appearance | Δ | Δ | ◯ | Δ | Δ | Δ | ◯ |

| | Example | | | | | |
|---|---|---|---|---|---|---|
| | 8 | 9 | 10 | 11 | 12 | 13 |
| AHRR | 39 | 30 | 30 | 29 | 30 | 40 |
| (kW/m²) | | | | | | |
| ASEA | 761 | 774 | 751 | 660 | 758 | 768 |
| (m²/g) | | | | | | |
| Vicat | 77 | 76 | 77 | 77 | 77 | 77 |
| softening | | | | | | |
| temperature | | | | | | |
| (° C.) | | | | | | |
| Dynamic | 18 | 23 | 25 | 16 | 17 | 25 |
| thermal | | | | | | |
| stability | | | | | | |
| (min) | | | | | | |
| Appearance | Δ | Δ | Δ | Δ | ◯ | Δ |

TABLE 4

| | Comparative Example | | | | | | | | | |
|---|---|---|---|---|---|---|---|---|---|---|
| | 1 | 2 | 3 | 4 | 5 | 6 | 7 | 8 | 9 | 10 |
| AHRR | 65 | 58 | 50 | 26 | 58 | 62 | 71 | 19 | 17 | 26 |
| (kW/m²) | | | | | | | | | | |
| ASEA (m²/g) | 814 | 762 | 758 | 730 | 762 | 771 | 822 | 623 | 657 | 726 |
| Vicat | 77 | 77 | 77 | 77 | 75 | 68 | 67 | 79 | 78 | 77 |
| softening | | | | | | | | | | |
| temperature | | | | | | | | | | |
| (° C.) | | | | | | | | | | |
| Dynamic | 24 | 12 | 10 | 21 | 13 | 24 | 36 | 9 | 21 | 13 |
| thermal | | | | | | | | | | |
| stability | | | | | | | | | | |
| (min) | | | | | | | | | | |
| Appearance | ◯ | Δ | Δ | X | Δ | Δ | ◯ | X | X | Δ |

### [Evaluation of Calender Press Molding Properties]

The results of evaluation obtained as in the following manners are shown in Tables 5 and 6.
(1) Determination of fire retardant properties: Compositions prepared by Examples 1 to 9 were kneaded at 180° C. by means of a calender roll to form sheets of 1 mm in thickness, six of which were laminated and press molded at 200° C. between heat plates for 15 minutes to form calender-press molded articles of 5 mm in thickness, followed by determination of their AHRR (kW/m²) and ASEA (m²/g) in a similar manner as described in the extruded articles.
(2) Evaluation of thermal properties: The Vicat softening temperature (° C.) of the thus molded articles was determined in a similar manner as described in the excluded articles.
(3) Heat stability of calender press molding: Compositions prepared by Examples 1 to 9 and Comparative Examples 1 to 10 were kneaded at 180° C. by means of a calender roll to form sheets of 0.5 mm in thickness, six of which were laminated and press molded at 200° C. between heat plates to form press molded articles of 2 mm in thickness. While keeping this situation of molding but putting off the upper heat plate, the articles were visually observed the color change and classified into two groups, i.e., “good” (more than 20 minutes) and “no good” (within 20 minutes), depending on a time period required to begin the color change.
(4) Appearance evaluation of calender-press molded articles: The superficial dispersing condition of the same articles as those used in the item (1) above were visually evaluated according to similar criterion as described above.

TABLE 5

| | Example | | | | | | | | |
|---|---|---|---|---|---|---|---|---|---|
| | 1 | 2 | 3 | 4 | 5 | 6 | 7 | 8 | 9 |
| AHRR | 34 | 27 | 28 | 22 | 26 | 30 | 27 | 42 | 33 |
| (kW/ | | | | | | | | | |
| m²) | | | | | | | | | |
| ASEA | 771 | 731 | 721 | 669 | 712 | 762 | 728 | 783 | 780 |
| (m²/g) | | | | | | | | | |
| Vicat | 77 | 78 | 78 | 78 | 79 | 78 | 78 | 77 | 77 |
| soften- | | | | | | | | | |
| ing | | | | | | | | | |
| tem- | | | | | | | | | |
| perature | | | | | | | | | |
| (° C.) | | | | | | | | | |
| Thermal | 25 | 20 | 20 | 20 | 20 | 25 | 20 | 25 | 25 |
| stability | | | | | | | | | |
| of press | | | | | | | | | |
| molding | | | | | | | | | |
| (min) | | | | | | | | | |
| Appear- | ◯ | ◯ | ◯ | ◯ | Δ | Δ | ◯ | ◯ | ◯ |
| ance | | | | | | | | | |

TABLE 6

| | Comparative Example | | | | | | | | | |
|---|---|---|---|---|---|---|---|---|---|---|
| | 1 | 2 | 3 | 4 | 5 | 6 | 7 | 8 | 9 | 10 |
| AHRR | 63 | 55 | 58 | 38 | 53 | 52 | 77 | 25 | 32 | 28 |
| (kW/m²) | | | | | | | | | | |
| ASEA (m²/g) | 832 | 776 | 763 | 721 | 763 | 762 | 829 | 663 | 641 | 715 |
| Vicat | 78 | 77 | 77 | 77 | 76 | 68 | 68 | 78 | 78 | 77 |
| softening | | | | | | | | | | |
| temperature | | | | | | | | | | |
| (° C.) | | | | | | | | | | |
| Thermal | 30 | 10 | 10 | 20 | 10 | 25 | 35 | 10 | 15 | 10 |
| stability | | | | | | | | | | |
| of press | | | | | | | | | | |
| molding | | | | | | | | | | |
| (min) | | | | | | | | | | |
| Appearance | ◯ | ◯ | Δ | X | ◯ | ◯ | ◯ | X | Δ | Δ |

### [Evaluation of Extrusion Press Molding Properties]

The results of evaluation obtained as in the following manners are shown in Tables 5 and 6.
(1) Determination of fire retardant properties: Compositions prepared by Examples 1 to 9 were kneaded at 180° C. by means of a twin-screw extruder to mold into boards of 10 mm in thickness and subsequently press molded at 200° C. between heat plates to form extrusion-press molded articles of 5 mm in thickness, followed by determination of their AHRR (kW/m²) and ASEA (m²/g) in a similar manner as described in the extruded articles.
(2) Evaluation of thermal properties: The Vicat softening temperature (° C.) of the thus molded articles was determined in a similar manner as described in the excluded articles.
(3) Heat stability of extrusion press molding: Compositions prepared by Examples 1 to 9 and Comparative Examples 1 to 10 were excluded by means of a twin-screw extruder to mold into boards of 4 mm in thickness and press molded at 200° C. between heat plates to form press molded articles of 2 mm in thickness. The time of pressing is extended for 5, 10, 15 minutes and so on, while samples were collected at each time period, visually observed the color change and classified into two groups, i.e., “good” (more than 15 minutes) and “no good” (within 15 minutes), depending on a time period required to begin the color change.
(4) Appearance evaluation of extrusion-press molded articles: The superficial dispersing condition of the same articles as those used in the item (1) above were visually evaluated according to similar criterion as described above.

TABLE 7

| | Example | | | | | | | | |
|---|---|---|---|---|---|---|---|---|---|
| | 1 | 2 | 3 | 4 | 5 | 6 | 7 | 8 | 9 |
| AHRR | 31 | 27 | 29 | 20 | 27 | 31 | 29 | 41 | 30 |
| (kW | | | | | | | | | |
| /m²) | | | | | | | | | |
| ASEA | 771 | 752 | 744 | 666 | 715 | 781 | 744 | 758 | 741 |
| (m²/g) | | | | | | | | | |
| Vicat | 77 | 77 | 7 | 77 | 77 | 77 | 77 | 76 | 77 |
| soften- | | | | | | | | | |
| ing | | | | | | | | | |
| tem- | | | | | | | | | |
| perature | | | | | | | | | |
| (° C.) | | | | | | | | | |
| Thermal | 20 | 15 | 15 | 20 | 15 | 20 | 15 | 15 | 20 |
| stability | | | | | | | | | |
| of | | | | | | | | | |
| ex- | | | | | | | | | |
| trusion | | | | | | | | | |
| press | | | | | | | | | |
| molding | | | | | | | | | |
| (min) | | | | | | | | | |
| Appear- | Δ | Δ | ◯ | ◯ | Δ | Δ | ◯ | ◯ | Δ |
| ance | | | | | | | | | |

TABLE 8

| | Comparative Example | | | | | | | | | |
|---|---|---|---|---|---|---|---|---|---|---|
| | 1 | 2 | 3 | 4 | 5 | 6 | 7 | 8 | 9 | 10 |
| AHRR | 68 | 59 | 52 | 24 | 57 | 63 | 74 | 21 | 30 | 31 |
| (kW/m²) | | | | | | | | | | |
| ASEA (m²/g) | 825 | 758 | 761 | 739 | 781 | 769 | 815 | 633 | 681 | 751 |
| Vicat | 77 | 77 | 77 | 77 | 75 | 68 | 66 | 78 | 78 | 77 |
| softening | | | | | | | | | | |
| temperature | | | | | | | | | | |
| (° C.) | | | | | | | | | | |
| Thermal | 20 | 10 | 10 | 15 | 10 | 15 | 25 | 10 | 15 | 10 |
| stability | | | | | | | | | | |
| of | | | | | | | | | | |
| extrusion | | | | | | | | | | |
| press | | | | | | | | | | |
| molding | | | | | | | | | | |
| (min) | | | | | | | | | | |
| Appearance | ◯ | ◯ | Δ | X | ◯ | Δ | ◯ | X | X | Δ |

### [Evaluation of Properties of Articles Molded by Different Processes]

Molded articles of a composition prepared in Example 4 exhibit approximately equivalent heat stability when they are molded by the extrusion process, the calender-press process and the extrusion followed by press process. The composition of Example 1 was molded by above mentioned processes respectively to yield articles of 5 mm and 10 mm in thickness. Only in the calender-press process, 5 or 10 sheets of 1 mm in thickness were laminated in a similar manner as described above.

Gloss-throwback caused by heating process, thickness consistency and resistance to solvents of the articles were evaluated according to the following manners and criterion. The result is shown in Table 9.

(1) Gloss-Throwback Caused by Heating Process
(1-1) After each piece of the molded articles of 5 mm in thickness was set horizontally, each edge face of another pieces having the same thickness and composition were fit vertically on the surface of the horizontal pieces and welded along each inner corner thereof with a rigid vinyl chloride welding rod of 3 mm in diameter by means of a welding gun while blowing heated air at 190° C. at a welding speed of 10 cm/minute. When each of two pieces were welded at right angles, a loss of gloss on the surface of articles near the welding rod was visually observed and evaluated according to the following criterion;
   ◯: no change in gloss
   Δ: slightly lost but practically useful
   x: obviously lost and not practical
(1-2) The molded articles of 5 mm in thickness were heated at 140° C. (in accordance with JIS 6745) and 170° C. (heat bending temperature) in a gear oven, visually observed their gloss-loss on the surface of molded articles and evaluated according to the following criterion:
   ◯: no change in gloss
   Δ: slightly lost but practically useful
   x: obviously lost and not practical

(2) Thickness Consistency
The molded articles of 10 mm in thickness were evaluated with regard to their thickness distribution based on a scattering rate R.

(3) Resistance to Solvents
The molded articles of 5 mm in thickness were soaked in a 100%-acetone solution for 30 minutes, observed their cleavage and evaluated according to the following criterion:
   ◯: no cleavage
   x: cleaved

TABLE 9

| | | | Calender/ | Extrusion/ |
|---|---|---|---|---|
| | | Extrusion | Press | Press |
| Gloss- | Welding | Δ | X | ◯ |
| throwback | Oven (140° C.) | ◯ | Δ | ◯ |
| | Oven (170° C.) | Δ | X | ◯ |
| Thickness | | ±2.5% | ±3.5% | ±1.3% |
| consistency | | | | |
| Resistance | | ◯ | X | ◯ |
| to solvents | | | | |

### Examples 14 to 22 and Comparative Examples 11 to 15

An organic tin stabilizer (4/1 mixture of dibutyl tin maleate polymer/dibutyl tin maleic ester available from Sankyo Organic Chemicals Co., Ltd. as a trade name “BM/90E”), a lead stabilizer (4/1 mixture of dibasic lead sulfate/dibasic lead stearate available from Mizusawa Chemical Co., Ltd as a trade name “TC/C18), a molybdenum compound (ammonium molybdate available from Nippon Inorganic Colour Co., Ltd. as a trade name “Molyan AHM”), basic compounds as will be shown in Table 10 and titanium oxide as a colorant in an amount will be also shown in the Table were added to 100 parts by weight of a vinyl chloride resin (vinyl chloride homopolymer; degree of polymerization (DC): 780) to yield fire retardant VC-base resin compositions of this invention.

### [Evaluation]

Fire retardant VC-based resin compositions of Examples 14 to 22 and Comparative Examples 11 to 15 were extruded to mold into sheets of 5 mm in thickness and then cut to prepare test pieces A of 20 mm×20 mm, which were evaluated with regard to the following properties. The result is shown in Table 10.

(1) Evaluation of Fire Retardant Properties
AHRR (kW/m²) and ASEA ((m²/g) of the test pieces A were determined by means of Atlas's Cone calorimeter according to ASTM E1354.

(2) Evaluation of Resistance to Color Change in Warm Water
The test pieces A were soaked in 20 ml of warmed pure water at 60° C., kept this situation for 48 hours and then determined the color change before and after warm-water soaking by means of a color-difference meter to obtain a value Δa.

(3) Evaluation of Hydrogen Ion Concentration
The test pieces A were soaked in 20 ml of warmed pure water at 60° C., kept this situation for 48 hours and then determined pH of the aqueous solution by a pH meter.

(4) Evaluation of Heat Stability
Sheet articles were molded in a similar manner as described above except that the thickness was 1 mm and cut to prepare test pieces B of 100 mm×100 mm., which were heated in an oven at 200° C. to visually determine a time period required to change their color to black. The test pieces were evaluated depending on the time period as in the following:
   ◯: more than 30 minutes
   Δ: more than 20 minutes and not more than 30 minutes
   x: less than 15 minutes

(5) Evaluation of Environmentally Affective Substances
Test pieces B were quantitatively analyzed by fluorescence X-ray spectrometry to detect metallic lead and evaluated as in the following:
   ◯: lead was not detected
   x: lead was detected

TABLE 10

| | Examples | | | | |
|---|---|---|---|---|---|
| | 14 | 15 | 16 | 17 | 18 |
| VC resin of DC 780 | 100 | 100 | 100 | 100 | 100 |
| Sn stbilizer | 3 | 3 | 3 | 3 | 3 |
| Pb stabilizer | — | — | — | — | — |
| <Mo compound> | 3 | 3 | 3 | 3 | 3 |
| ammonium molybdate | | | | | |
| <Basic compound> | | | | | |
| 1. aminocarboxylic acid | 1 | — | 1 | 1 | 0.3 |
| derivative | | | | | |
| 1,3-butanediol- | | | | | |
| bis(3-aminocrotonate) | | | | | |
| 2. urea derivative | — | — | — | — | — |
| N,N′-diphenylthiourea | | | | | |
| 3. dolomite derivative | 0.3 | 0.3 | — | — | — |
| slightly calcined | | | | | |
| dolomite | | | | | |
| 4. metal soap | — | 0.5 | 0.5 | — | — |
| magnesium stearate | | | | | |
| Titanium oxide | 5 | 5 | 5 | 5 | 5 |
| Environ. affective | ◯ | ◯ | ◯ | ◯ | ◯ |
| substance (Pb compound) | | | | | |
| Fire retardant properties | | | | | |
| AHRR (kW/m²) | 13 | 15 | 23 | 20 | 8 |
| ASEA (m²/g) | 536 | 601 | 721 | 704 | 654 |
| Resistance to color | | | | | |
| change | | | | | |
| Δa after 60° C., | 0.22 | 0.20 | 0.02 | −0.08 | −0.29 |
| 30 min. soak | | | | | |
| pH after 60° C., | 7.5 | 7.3 | 6.9 | 6.4 | 6.0 |
| 30 min. soak | | | | | |
| Heat stability | ◯ | ◯ | ◯ | Δ | Δ |
| time to change to black | | | | | |

| | Examples | | | |
|---|---|---|---|---|
| | 19 | 20 | 21 | 22 |
| VC resin of DC 780 | 100 | 100 | 100 | 100 |
| Sn stbilizer | 3 | 3 | 3 | 3 |
| Pb stabilizer | — | — | — | — |
| <Mo compound> | 3 | 6 | 3 | 3 |
| ammonium molybdate | | | | |
| <Basic compound> | | | | |
| 1. aminocarboxylic acid | — | 1 | — | — |
| derivative | | | | |
| 1,3-butanediol- | | | | |
| bis(3-aminocrotonate) | | | | |
| 2. urea derivative | 1 | — | — | — |
| N,N′-diphenylthiourea | | | | |
| 3. dolomite derivative | — | — | 0.3 | — |
| slightly calcined dolomite | | | | |
| 4. metal soap | — | — | — | 1 |
| magnesium stearate | | | | |
| Titanium oxide | 5 | 5 | 5 | 5 |
| Environ. affective substance | ◯ | ◯ | ◯ | ◯ |
| (Pb compound) | | | | |
| Fire retardant properties | | | | |
| AHRR (kW/m²) | 16 | 6 | 12 | 33 |
| ASEA (m²/g) | 729 | 631 | 592 | 698 |
| Resistance to color change | | | | |
| Δa after 60° C., 30 min. soak | −0.01 | −0.33 | −0.18 | −0.11 |
| pH after 60° C., 30 min. soak | 6.2 | 5.8 | 7.1 | 6.2 |
| Heat stability | Δ | Δ | ◯ | ◯ |
| time to change to black | | | | |

| | Comparative Examples | | | | |
|---|---|---|---|---|---|
| | 11 | 12 | 13 | 14 | 15 |
| VC resin of DC 780 | 100 | 100 | 100 | 100 | 100 |
| Sn stbilizer | 3 | 3 | 3 | 3 | — |
| Pb stabilizer | — | — | — | — | 3 |
| <Mo compound> | 0 | 10 | 3 | 3 | 3 |
| ammonium molybdate | | | | | |
| <Basic compound> | | | | | |
| 1. aminocarboxylic acid | 1 | 1 | 5 | — | — |
| derivative | | | | | |
| 1,3-butanediol- | | | | | |
| bis(3-aminocrotonate) | | | | | |
| 2. urea derivative | — | — | — | — | — |
| N,N′-diphenylthiourea | | | | | |
| 3. dolomite derivative | — | — | — | — | — |
| slightly calcined | | | | | |
| dolomite | | | | | |
| 4. metal soap | — | — | — | — | — |
| magnesium stearate | | | | | |
| Titanium oxide | 5 | 5 | 5 | 5 | 5 |
| Environ. affective | ◯ | ◯ | ◯ | ◯ | X |
| substance (Pb compound) | | | | | |
| Fire retardant properties | | | | | |
| AHRR (kW/m²) | 65 | 4 | 66 | 15 | 6 |
| ASEA (m²/g) | 825 | 293 | 850 | 607 | 596 |
| Resistance to color | | | | | |
| change | | | | | |
| Δa after 60° C., | −0.22 | −2.11 | −0.05 | −1.10 | 0.20 |
| 30 min. soak | | | | | |
| pH after 60° C., | 6.3 | 4.2 | 6.3 | 5.1 | 7.2 |
| 30 min. soak | | | | | |
| Heat stability | ◯ | X | X | ◯ | ◯ |
| time to change to black | | | | | |

It is clear from Table 10 that molded articles of exceeded fire retardant properties, resistance to color change and heat stability are yielded by this invention, while those articles which exhibit all of these properties can not be obtained in cases where a molybdenum compound is not added (Comparative Example 11) or excessively added (Comparative Example 12), or a basic compound is excessively added (Comparative Example 13) or is not added (Comparative Examples 14 and 15).

Exceeded resistance to color change is obtained in Comparative Example 15 in which no basic compound is added. The reason why is presumed that the lead stabilizer used in this case is more basic than the organic tin compound used in this invention.

### Examples 23 to 33 and Comparative Examples 16 to 24

### Preparation of Surface-Coated Flame Retardant Agent

In 2 liter of water, 200 g of nucleating agents (as will be shown in Tables 11 and 12) were suspended and further added an aqueous suspension of molybdate (as will also be shown similarly) to deposit the molybdenum compound on the surface of the nucleating agent by adjusting pH in the aqueous solution and controlling temperature, followed by filtration and washing with water. When a fire retardant aid was simultaneously used with the molybdate, a weight ratio of molybdate/fire retardant aid was 1, while the molybdate aqueous suspension was added in an amount of 20% by weight as MoO₃ in the surface-coated flame retardant agent.

The thus formed solid was dried, calcined and milled to yield flame retardant agents in which the molybdenum compound was coated with titanium oxide as a nucleating agent and the basic compound.

### [Preparation of Fire Retardant VC-Based Resin Composition]

The surface-coated flame retardant agents in an amount as will be shown in Tables 11 and 12 were mixed homogeneously with a VC-based resin and stabilizers to yield the present and comparative fire retardant VC-resin compounds as compound powders.

These fire retardant VC-based resin compositions were molded by either one of extrusion process, calender-press process or extrusion followed by press process to form the present and comparative board articles of dimensions as will be described below. Their properties were evaluated as in the following and the result is shown in Tables 11 and 12.

(1) Evaluation of Fire Retardant Properties
AHRR (kW/m²) and ASEA ((m²/g) of molded articles (5 mm thick×20 mm width×20 mm length) were determined by means of Atlas's Cone calorimeter according to ASTM E1354.

(2) Evaluation of Resistance to Color Change in Warm Water
The molded articles (similarly 5 mm×20 mm×20 mm) were soaked in 20 ml of warmed pure water at 60° C., kept this situation for 48 hours and then determined the color change before and after warm-water soaking by means of a color-difference meter to obtain a value Δa.

(3) Evaluation of Heat Stability
The molded articles (similarly 1 mm×20 mm×20 mm) were heated in an oven at 200° C. to visually determine a time period required to change their color to black. The test pieces were evaluated depending on the time period as in the following:
   ◯: more than 30 minutes
   Δ: more than 20 minutes
   x: less than 15 minutes

(4) Evaluation of Environmentally Affective Substances
The molded articles (similarly 5 mm×20 mm×20 mm) were quantitatively analyzed by fluorescence X-ray spectrometry to detect metallic lead and evaluated as in the following:
   ◯: lead was not detected
   x: lead was detected

(5) Evaluation of Chemical Resistance
The molded articles (similarly 1 mm×20 mm×20 mm) were soaked in a 35%-HCl aqueous solution at 60° C. for 48 hours and determined the rate of change in weight before and after soaking according to JIS 6745 and evaluated as in the following;
   ◯: change rate less than 0.5%
   x: change rate not less than 0.5%

(6) Evaluation of Dispersion Properties
The molded articles (similarly 5 mm×20 mm×20 mm) were visually observed with regard to dispersion of the flame retardants and evaluated as in the following:
   ◯: no aggregation
   x: aggregated

(7) Evaluation of Gloss Throwback Caused by Heating Process, Thickness Consistency and Resistance to Solvents
Evaluation was done according to similar manners and criterion employed to evaluate articles of Example 4.

TABLE 11

| | | | Example | | |
|---|---|---|---|---|---|
| | | | 23 | 24 | 25 |
| VC resin of DP 780 | | | 100 | 100 | 100 |
| Pb stabilizer | | | — | — | — |
| Sn stabilizer | | | 2 | 2 | 2 |
| High temperature-decomposition promoter | | | | | |
| (flame retardant) | | | | | |
| surface | nucleator | | | | |
| coating agent | | (Ti | | | |
| (Mo compd.) | (basic compd.) | oxide) | | | |
| (NH₄)₂MoO₄ | precipitated | — | 3 | 3 | 3 |
| (20%) | BaSo₄ (80%) | | | | |
| Na-A type zeolite | | | 0.5 | 0.5 | 0.5 |
| Molding process* | | | A | B | C |
| Fire retardant properties: | | | | | |
| AHRR (kW/m²) | | | 23 | 23 | 23 |
| ASEA (m²/g) | | | 705 | 705 | 705 |
| Resistance to color change in warm water Δa | | | −0.03 | −0.03 | −0.03 |
| (at 60° C. for 48 hr) | | | | | |
| Heat stability | | | Δ | Δ | Δ |
| Environmentally affective subst. (Pb compd.) | | | ◯ | ◯ | ◯ |
| Chemical resistance | | | 0.35 | 0.35 | 0.35 |
| (at 60° C. for 48 hr. in 35%-HCl soln.) | | | | | |
| Appearance (dispersion properties) | | | ◯ | ◯ | ◯ |
| Gloss throwback: | | | | | |
| welding | | | ◯ | X | Δ |
| oven (140° C.) | | | ◯ | Δ | ◯ |
| (170° C.) | | | ◯ | X | Δ |
| Thickness consistency (%) | | | ±1.5 | ±3 | ±2 |
| Resistance to solvents | | | ◯ | X | ◯ |
| | | | Example | | |
| | | | 29 | 30 | 31 |
| VC resin of DP 780 | | | 100 | 100 | 100 |
| Pb stabilizer | | | — | — | — |
| Sn stabilizer | | | 2 | 2 | 2 |
| High temperature-decomposition promoter | | | | | |
| (flame retardant) | | | | | |
| surface | nucleator | | | | |
| coating agent | | (Ti | | | |
| (Mo compd.) | (basic compd.) | oxide) | | | |
| (NH₄)₂MoO₄ | precipitated | — | 3 | — | |
| (10%) | BaSO₄ (80%) | | | | |
| and MoO3 | | | | | |
| (10%) | | | | | |
| (NH₄)₂MoO₄ | precipitated | Ti | — | 3 | — |
| (20%) | BaSO₄ (40%) | oxide | | | |
| | | (40%) | | | |
| (NH₄)₂MoO₄ | MgO (10%) | Ti | — | — | 3 |
| (20%) | | oxide | | | |
| | | (70%) | | | |
| Na-A type zeolite | | | 0.5 | 0.5 | 0.5 |
| Molding process* | | | A | A | A |
| Fire retardant properties: | | | | | |
| AHRR (kW/m²) | | | 21 | 20 | 25 |
| ASEA (m²/g) | | | 689 | 682 | 721 |
| Resistance to color change in warm water Δa | | | 0.26 | 0.16 | −0.09 |
| (at 60° C. for 48 hr) | | | | | |
| Heat stability | | | Δ | Δ | Δ |
| Environmentally affective subst. (Pb compd.) | | | ◯ | ◯ | ◯ |
| Chemical resistance | | | 0.34 | 0.34 | 0.4 |
| (at 60° C. for 48 hr. in 35%-HCl soln.) | | | | | |
| Appearance (dispersion properties) | | | ◯ | ◯ | ◯ |
| Gloss throwback: | | | | | |
| welding | | | ◯ | ◯ | ◯ |
| oven (140° C.) | | | ◯ | ◯ | ◯ |
| (170° C.) | | | ◯ | ◯ | ◯ |
| Thickness consistency (%) | | | ±1.5 | ±1.5 | ±1.5 |
| Resistance to solvents | | | ◯ | ◯ | ◯ |
| VC resin of DP 780 | | | 100 | 100 | 100 |
| Pb stabilizer | | | — | — | — |
| Sn stabilizer | | | 2 | 2 | 2 |
| High temperature-decomposition promoter | | | | | |
| (flame retardant) | | | | | |
| surface | nucleator | | | | |
| coating agent | | (Ti | | | |
| (Mo compd.) | (basic compd.) | oxide) | | | |
| (NH₄)₂MoO₄ | slightly | Ti | 3 | — | — |
| (20%) | calcied | oxide | | | |
| | dolomite | (70%) | | | |
| | (10%) | | | | |
| (NH₄)₂MoO₄ | aminocrotonic | Ti | — | 3 | — |
| (20%) | ester (10%) | oxide | | | |
| | | (70%) | | | |
| (NH₄)₂MoO₄ | aminocrotonic | Ti | — | — | 3 |
| (20%) | ester (80%) | oxide | | | |
| | | (70%) | | | |

| | | | |
|---|---|---|---|
| Na-A type zeolite | 0.5 | 0.5 | 0.5 |
| Molding process* | A | A | A |
| Fire retardant properties: | | | |
| AHRR (kW/m²) | 32 | 38 | 42 |
| ASEA (m²/g) | 754 | 768 | 645 |
| Resistance to color change in warm water Δa | 0.29 | −0.04 | −0.15 |
| (at 60° C. for 48 hr) | | | |
| Heat stability | Δ | ◯ | ◯ |
| Environmentally affective subst. (Pb compd.) | ◯ | ◯ | ◯ |
| Chemical resistance | 0.48 | 0.28 | 0.32 |
| (at 60° C. for 48 hr. in 35%-HCl soln.) | | | |
| Appearance (dispersion properties) | ◯ | ◯ | ◯ |
| Gloss throwback: | | | |
| welding | ◯ | ◯ | ◯ |
| oven (140° C.) | ◯ | ◯ | ◯ |
| (170° C.) | ◯ | ◯ | ◯ |
| Thickness consistency (%) | ±1.5 | ±1.5 | ±1.5 |
| Resistance to solvents | ◯ | ◯ | ◯ |

Example

| | 32 | 33 |
|---|---|---|
| VC resin of DP 780 | 100 | 100 |
| Pb stabilizer | — | — |
| Sn stabilizer | 2 | 2 |

| High temperature-decomposition promoter | |
|---|---|
| (flame retardant) | |
| surface | nucleator |

| coating agent | | (Ti | | |
|---|---|---|---|---|
| (Mo compd.) | (basic compd.) | oxide) | | |
| (NH₄)₂MoO₄ | precipitated | Ti | — | 6 |
| (20%) | BaSO₄ (80%) | oxide | | |
| | | — | | |
| (NH₄)₂MoO₄ | MgO (10%) | — | 3 | — |
| (20%) | | | | |

| | | |
|---|---|---|
| Na-A type zeolite | 0.5 | 0.5 |
| Molding process* | A | A |
| Fire retardant properties: | | |
| AHRR (kW/m²) | 21 | 6 |
| ASEA (m²/g) | 669 | 628 |
| Resistance to color change in warm water Δa | 0.20 | −0.19 |
| (at 60° C. for 48 hr) | | |
| Heat stability | ◯ | Δ |
| Environmentally affective subst. (Pb compd.) | ◯ | ◯ |
| Chemical resistance | 0.47 | 0.47 |
| (at 60° C. for 48 hr. in 35%-HCl soln.) | | |
| Appearance (dispersion properties) | ◯ | ◯ |
| Gloss throwback: | | |
| welding | ◯ | ◯ |
| oven (140° C.) | ◯ | ◯ |
| (170° C.) | ◯ | ◯ |
| Thickness consistency (%) | ±1.5 | ±1.5 |
| Resistance to solvents | ◯ | ◯ |

*Molding process A: Extrusion followed by press B: Calender-press C: Extrusion

TABLE 12

| | | | Comparative Example | | |
|---|---|---|---|---|---|
| | | | 16 | 17 | 18 |
| VC resin of DP 780 | | | 100 | 100 | 100 |
| Pb stabilizer | | | — | — | |
| Sn stabilizer | | | 2 | 2 | 2 |
| High temperature-decomposition promoter | | | | | |
| (flame retardant) | | | | | |
| surface | nucleator | | | | |
| coating agent | | (Ti | | | |
| (Mo compd.) | (basic compd.) | oxide) | | | |
| (NH₄)₂MoO₄ | precipitated | — | — | 3 | — |
| (20%) | BaSO₄ (80%) | | | | |
| (NH₄)₂MoO₄ | | Ti | — | — | 3 |
| (20%) | | oxide | | | |
| | | (80%) | | | |

| Na-A type zeolite | | | 1 | — | 0.5 |
|---|---|---|---|---|---|
| Molding process* | | | A | A | A |
| Fire retardant properties: | | | | | |
| AHRR (kW/m²) | | | 97 | 23 | 19 |
| ASEA (m²/g) | | | 856 | 697 | 643 |
| Resistance to color change in warm water Δa | | | −0.02 | −0.11 | −0.69 |
| (at 60° C. for 48 hr) | | | | | |
| Heat stability | | | ◯ | X | Δ |
| Environmentally affective subst. (Pb compd.) | | | ◯ | ◯ | ◯ |
| Chemical resistance | | | 0.23 | 0.29 | 0.31 |
| (at 60° C. for 48 hr. in 35%-HCl soln.) | | | | | |
| Appearance (dispersion properties) | | | ◯ | ◯ | ◯ |
| Gloss throwback: | | | | | |
| welding | | | ◯ | ◯ | ◯ |
| oven (140° C.) | | | ◯ | ◯ | ◯ |
| (170° C.) | | | ◯ | ◯ | ◯ |
| Thickness consistency (%) | | | ±1.5 | ±1.5 | ±1.5 |
| Resistance to solvents | | | ◯ | ◯ | ◯ |
| | | | Comparative Example | | |
| | | | 19 | 20 | 21 |
| VC resin of DP 780 | | | 100 | 100 | 100 |
| Pb stabilizer | | | — | — | |
| Sn stabilizer | | | 2 | 2 | 2 |
| High temperature-decomposition promoter | | | | | |
| (flame retardant) | | | | | |
| surface | nucleator | | | | |
| coating agent | (basic | (Ti | | | |
| (Mo compd.) | compd.) | oxide) | | | |
| (NH₄)₂MoO₄ | — | Ti | 3 | — | — |
| (20%) | | oxide | | | |
| | | (70%) + | | | |
| | | Al₂O₃ | | | |
| | | (10%) | | | |
| (NH₄)₂MoO₄ | — | Al₂O₃ | — | 3 | — |
| (20%) | | (80%) | | | |
| (NH₄)₂MoO₄ | — | phos- | — | — | 3 |
| (20%) | | phoric | | | |
| | | ester | | | |
| | | (80%) | | | |

| Na-A type zeolite | | | 0.5 | 0.5 | 0.5 |
|---|---|---|---|---|---|
| Molding process* | | | A | A | A |
| Fire retardant properties: | | | | | |
| AHRR (kW/m²) | | | 15 | 23 | 23 |
| ASEA (m²/g) | | | 674 | 674 | 674 |
| Resistance to color change in warm water Δa | | | −0.72 | −0.91 | −0.82 |
| (at 60° C. for 48 hr) | | | | | |
| Heat stability | | | Δ | Δ | ◯ |
| Environmentally affective subst. (Pb compd.) | | | ◯ | ◯ | ◯ |
| Chemical resistance | | | 0.34 | 0.48 | 0.41 |
| (at 60° C. for 48 hr. in 35%-HCl soln.) | | | | | |
| Appearance (dispersion properties) | | | ◯ | ◯ | ◯ |
| Gloss throwback: | | | | | |
| welding | | | ◯ | ◯ | ◯ |
| oven (140° C.) | | | ◯ | ◯ | ◯ |
| (170° C.) | | | ◯ | ◯ | ◯ |
| Thickness consistency (%) | | | ±1.5 | ±1.5 | ±1.5 |
| Resistance to solvents | | | ◯ | ◯ | ◯ |
| | | | Comparative Example | | |
| | | | 22 | 23 | 24 |
| VC resin of DP 780 | | | 100 | 100 | 100 |
| Pb stabilizer | | | — | — | — |
| Sn stabilizer | | | 2 | 2 | 2 |
| High temperature-decomposition promoter | | | | | |
| (flame retardant) | | | | | |
| surface | nucleator | | | | |
| coating agent | | (Ti | | | |
| (Mo compd.) | (basic compd.) | oxide) | | | |
| (NH₄)₂MoO₄ | precipitated | — | — | 10 | 3 |
| (20%) | BaSo₄ (80%) | | | | |

| | | | |
|---|---|---|---|
| Na-A type zeolite | 0.5 | 0.5 | 0.5 |
| Molding process* | A | B | C |
| Fire retardant properties: | | | |
| AHRR (kW/m²) | 23 | 23 | 23 |
| ASEA (m²/g) | 705 | 705 | 705 |
| Resistance to color change in warm water Δa | −0.03 | −0.03 | −0.03 |
| (at 60° C. for 48 hr) | | | |
| Heat stability | Δ | Δ | Δ |
| Environmentally affective subst. (Pb compd.) | ◯ | ◯ | ◯ |
| Chemical resistance | 0.35 | 0.35 | 0.35 |
| (at 60° C. for 48 hr. in 35%-HCl soln.) | | | |
| Appearance (dispersion properties) | ◯ | ◯ | ◯ |
| Gloss throwback: | | | |
| welding | ◯ | X | Δ |
| oven (140° C.) | ◯ | Δ | ◯ |
| (170° C.) | ◯ | X | Δ |
| Thickness consistency (%) | ±1.5 | ±3 | ±2 |
| Resistance to solvents | ◯ | X | ◯ |

*Molding process A: Extrusion followed by press

It is clear from Tables 11 and 12 that each ingredient of the composition is successfully dispersed in the present fire retardant VC-resin composition and articles molded therefrom, which exhibit an excellent appearance without causing inferiority in dispersion and bear remarkable resistance to color change in warm water, fire retardant properties, resistant to solvents, etc.

On the other hand, those articles yielded by Comparative Examples lack some of above mentioned properties.

### INDUSTRIAL APPLICABILITY

The fire retardant VC-based resin composition of this invention exhibit excellent fire retardant properties and also easily yields various kinds of molded articles by a variety of molding processes because of its prominent molding processability. The thus molded articles are quite fire retardant, emit a lesser amount of smoke, bear high softening temperature and exhibit an excellent appearance.

Accordingly articles molded from the resin composition of this invention are useful as internal and external materials for transporters such as airplanes, ships and vehicles; interior and exterior building materials; daily necessities such as furniture and stationeries; housings for electric home appliances and electronic devices; semiconductor parts; etc.

Especially, those articles molded by an extrusion followed by press process are remarkably resistant to solvents and chemicals without causing gloss throwback due to heating and exhibit high thickness consistency and thus, are quite useful as a starting component for various industrial materials as described above.

While the invention has been explained with reference to the specific embodiments of the invention, the explanation is illustrative and the invention is limited only by the appended claims.

What is claimed is:

1. A fire retardant VC-based resin composition, comprising:
100 parts by weight of a VC-based resin,
0.05 to 8 parts by weight of at least one molybdenum compound anti-smoke agent, and
0.1 to 3 parts by weight of an alkaline compound.

2. A fire retardant VC-based resin composition according to claim 1, wherein the molybedenum compounds comprise one or more of molybdenum oxide, molybdenum trioxide, molybdic acid, ammonium molybdate, ammonium octamolybdate, zinc molybdate, calcium molybdate, zinc-calcium molybdate, sodium molybdate, molybdenum disulfide, melamine β-molybdate.

3. A fire retardant VC-based resin composition according to claim 1, wherein the alkaline compound comprises one or more of an alkaline metal oxide or hydroxide; basic salt of carbonic acid, sulfuric acid, sulfurous acid, phosphoric acid and phosphorous acid; basic metal oxide including beryllium oxide, magnesium oxide, calcium oxide, strontium oxide, barium oxide, silicon oxide, aluminum oxide and zinc oxide; basic inorganic pigment including lime carbonate, ultramarine, barium sulfate and precipitated barium sulfate; dolomite compounds, thiourea and N,N′-diphenylthiourea; aminocarbonic acid derivatives including β-aminocrotonic acid ester, N-lauroyllysine, tris(2-hydroxyethyl) isocyanurate and tris(epoxypropyl) isocyanurate; indoles including 2-phenylindole; polyamine including N,N″-diphenylethylenediamine, diethylenetriamine and hexamethylenetetramine; phenyl-α-naphthylamine, aldol-α-naphthylamine and 6-ethoxy-2,2,4-trimethyl-1,2-dihydroquinoline; (2′-hydroxyphenyl)benzotriazole; bis(2,2,6,6-tetramethylpiperazinyl)-4-cevacate; hydrazine derivatives; thiocarbamine derivatives; and metal soap.

4. A fire retardant VC-based resin composition, consisting essentially of:
100 parts by weight of a VC-based resin,
0.05 to 8 parts by weight of molybdenum compound anti-smoke agent, and
0.1 to 3 parts by weight of an alkaline compound.
